(19) United States
(12) Patent Application Publication
(10) Pub. No.: US 2008/0133314 A1
(43) Pub. Date: Jun. 5, 2008

(54) DETERMINING ADVERTISEMENT PLACEMENT ON SEARCH RESULTS PAGE TO IMPROVE REVENUE GENERATION

(75) Inventor: Philip G. Chiu, Alhambra, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/566,566

(22) Filed: Dec. 4, 2006

(51) Int. Cl. G06Q 30/00; G06Q 10/00; G06F 17/30

(52) U.S. Cl. 705/10; 705/14

(57) ABSTRACT

Placement of advertisements on a display is determined. For example, the advertisements may correspond to a search term and may be displayed in conjunction with search results for that search term. An indication of the advertisements to display is received. An iterative optimization algorithm is applied to metadata regarding revenue-generating characteristics for the advertisements to determine a placement of the advertisements relative to a display. A signal is generated indicating the determined placement.

### BACKGROUND

It is known to rank various advertisements for placement on a web page, such as on a search results web page. Using the search engine example, different portions of the search results page may gamer the search engine provider varying amounts of revenue based on a perception (which may be based on reality) that some portions of the web page are “worth more” than other portions of the web page. In general, according to a simplistic advertisement placement algorithm, those advertisements for which it is predicted relatively more revenue will be generated are given relatively more prominent placement, whereas advertisements for which it is predicted relatively less revenue will be generated are given less prominent placement. The predicted revenue amounts are generally based on the amount an advertiser is willing to pay, on a per-click basis, to place the advertisement, as well as an expected click-through rate for the advertisement, which is typically based on historical data.

### SUMMARY

Placement of advertisements on a display is determined. For example, the advertisements may correspond to a search term and may be displayed in conjunction with search results for that search term. An indication of the advertisements to display is received. An iterative optimization algorithm is applied to metadata regarding revenue-generating characteristics for the advertisements to determine a placement of the advertisements relative to a display. A signal is generated indicating the determined placement.

### BRIEF DESCRIPTION OF THE DRAWINGS

FIG. 1 is a block diagram illustrating an example architecture of a system to determine advertisement placement to improve revenue generation.

FIG. 2 is a flowchart illustrating a method of generating placement configurations for various search terms.

FIG. 3 is a flowchart illustrating an example process to cause search results to be displayed based on a search term provided by a user and, furthermore, to display advertisements in conjunction with the search results.

### DETAILED DESCRIPTION

The inventor has realized that an improved advertisement placement algorithm may be utilized and, in particular, that an iterative optimization algorithm can be used to improve revenue realization from advertisement placement. For example, search engine services, accessible to searchers via a browser executing on a client connected to a network such as the internet, cause search results to be displayed based on a search term (sometimes called a search query) provided by a searcher.

In conjunction with causing the search results to be displayed, the search engine services typically also cause advertisements to be displayed. The advertisements that are caused to be displayed are also based on the search term provided by the searcher. It is expected that the searcher, in addition to viewing the search results, will also activate an advertisement (typically by clicking on the advertisement).

For example, when an advertisement is activated, the search engine service provider may receive revenue from the advertiser. The amount of revenue received from the advertiser may be largely based on bidding by the advertisers to have advertising displayed based on one or more search terms. Such bidding may carried out using, for example, a bid tool provided as part of the Yahoo!® Search Marketing tool suite.

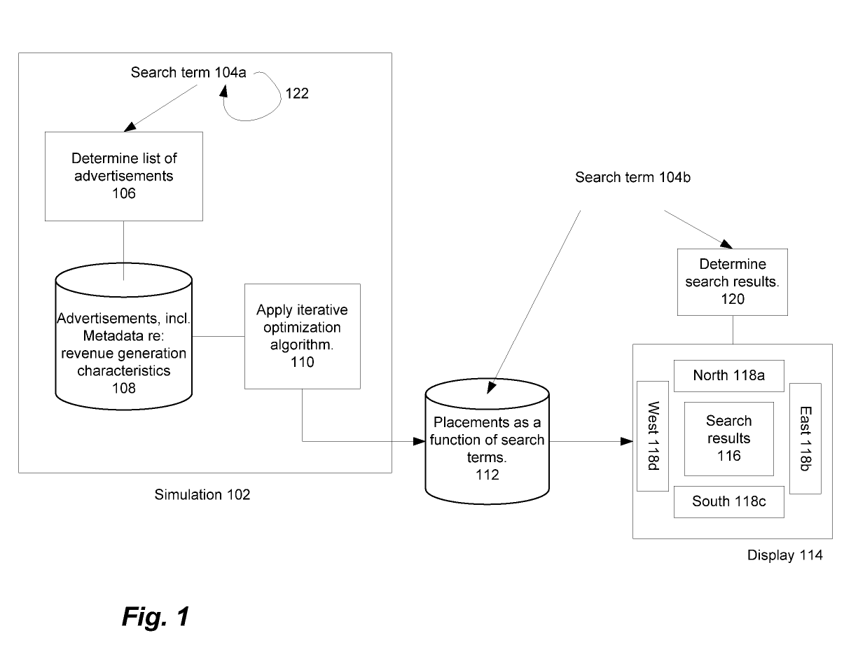

FIG. 1 illustrates an example architecture of a system to determine advertisement placement to improve revenue generation. A simulation 102 is employed to determine an advertisement placement 112 for the search term 104a. The simulation 102 may be employed to determine advertisement placement 112 for a plurality of search terms on which advertisers have bid.

When a user provides the search term (denoted as 104b when the search term is user-provided, as opposed to being denoted as 104a when provided to the simulation 102), search results are determined (120) and a search engine display page 114 is generated that includes the search results. The determined advertisement placement 112 is also used in generating the search engine display page 114, to include the advertisements.

More particularly with regard to the simulation 102, the search term 104a is used (106) to determine a list of advertisements to be potentially displayed in conjunction with search results corresponding to the search term 104a. This may include, for example, consulting a database maintained by a bid tool such as is provided as part of the Yahoo!® Search Marketing tool suite, as mentioned above. Furthermore, a data store 108 includes metadata regarding revenue generation characteristics of the advertisements. The metadata regarding revenue generation characteristics of an advertisement may include, for example, revenue per click, click through rate and search volume.

An iterative optimization algorithm 110 is applied at least to the metadata regarding revenue generation, to determine a placement of the advertisements. A determined placement of the advertisements may be, for example, a placement that optimizes the revenue that may be generated from the advertisements. The determined placement is stored in a store 112, in correspondence with the search term, for later use when the advertisements are actually displayed on a display page 114 in conjunction with search results.

For example, the display page 14 may include a search results portion 116 and may also include (in the FIG. 1 example) “north 118a,” “east 118b,” “south 118c” and “west 118d” advertisement display portions (generically, advertisement display portions 118). Particular ones of the advertisement display portions 118 are deemed to be more valuable than other one of the advertisement display portions 118 and, thus, in general, the more valuable advertisement display portions 118 should be used to display advertisements that are likely to generate relatively higher revenue.

This may be likened, for example, to a plot of land in Manhattan (relatively valuable) which it would generally be desirable to employ for relatively high revenue generation (e.g., a high-rise office or residence building) rather than for relatively low revenue generation (e.g., a one-story manufacturing plant). Furthermore, given a number of potential uses that all may have different levels of revenue generation potential (based on historical data), there would generally be an optimal placement of such uses among the various available plots, at least with regard to revenue generation purposes. In general, over time, the marketplace tends to allocate real estate uses such that placement is optimized. (This may be considered a simplification, since it does not account for other non-economic factors that may be present.)

In accordance with the FIG. 1 example, as discussed above, the iterative optimization algorithm 110 of the simulation 102 is applied to the metadata 108 to determine a placement of the advertisements. For example, the iterative optimization algorithm may iterate over various proposed advertisement placements, determining a predicted overall revenue rate for each proposed advertisement placement until settling on a proposed placement that is deemed to be appropriate (or even optimal) with regard to revenue generation. For example, the predicted revenue for a proposed advertisement placement may be represented by the average revenue per listed advertisement, i.e., (Revenue/Bidded Searches)/(Number of possible advertisements).

In one example, the iterative optimization algorithm is a modified simulated annealing algorithm. A simulated annealing algorithm, which takes its name from annealing in metallurgy, includes locating a good approximation to the global optimum configuration in a large configuration space. For background, see “Optimization by Simulated Annealing,” S. Kirkpatrick, C. D. Gelatt, Jr., M. P. Vecchi, Science, Number 4598, 13 May 1983. Here, the simulated annealing algorithm is employed such that each configuration in the configuration space is a possible configuration of displaying advertisements on a display such as the display page 114.

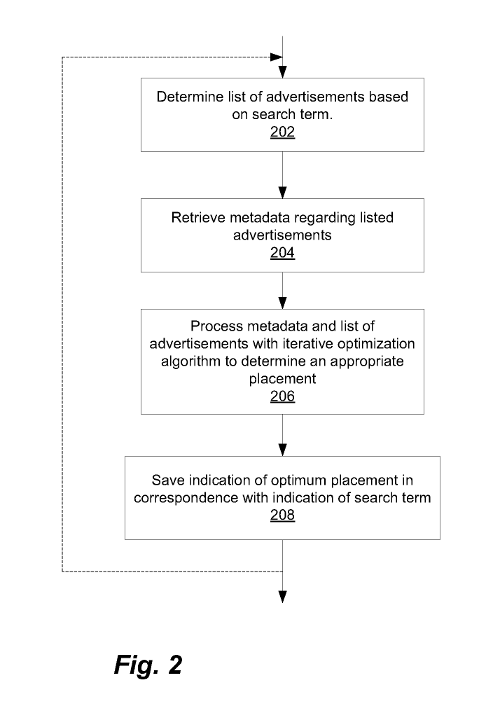

FIG. 2 is a flowchart illustrating a method of generating placement configurations for various search terms. At step 202, the list of advertisements is determined based on a particular search term. At step 204, the metadata regarding the advertisements is retrieved. At step 206, the metadata and the list of advertisements are processed by an iterative optimization algorithm to determine a placement of the advertisements. At step 208, an indication of the determined placement is saved in correspondence with an indication of the particular search term. Steps 202 to 208 may be repeated for additional search terms—as many as millions of search terms. (This is also indicated by the arrow 122 in FIG. 1.) In this way, placement of advertisements may be determined for most, if not all, of the search terms for advertisements will be potentially displayed in conjunction with search results corresponding to those search terms.

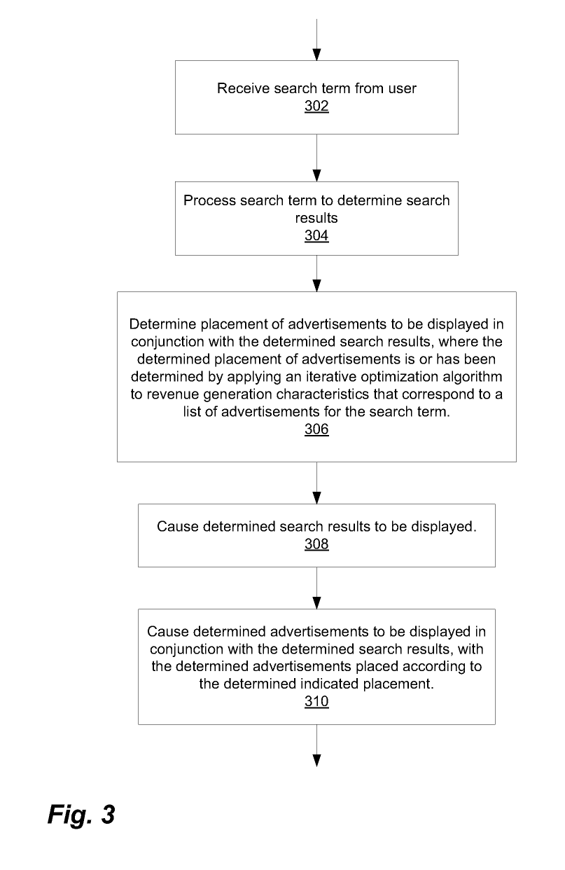

FIG. 3 is a flowchart illustrating an example process to cause search results to be displayed for a search term provided by a user and, furthermore, to display advertisements in conjunction with the search results. At step 302, the search term is received from the user (e.g., by a search engine service, such as Yahoo!® search, which can be reached at http://search.yahoo.com/). At step 304, the search term is processed (e.g., by processing of the search engine service) to determine search results.

At step 306, the indicated placement of advertisements to be displayed in conjunction with the determined search results is determined. The determined indicated placement of advertisements is or has been determined by applying an iterative optimization algorithm to revenue generation characteristics that correspond to a list of advertisements for the search term.

At step 308, the determined search results are caused to be displayed to the user, e.g., in a window of a browser from which the user caused the search term to be provided). At step 310, the determined advertisements are caused to be displayed in conjunction with the determined search results, with the determined advertisements placed according to the determined indicated placement.

We have described an advertisement placement algorithm in which an iterative optimization algorithm is used to improve revenue realization from advertisement placement.

1. A method to determine placement of advertisements on a display, comprising:
receiving an indication of the advertisements to display;
applying an iterative optimization algorithm to metadata regarding revenue-generating characteristics for the advertisements to determine a placement of the advertisements relative to a display; and
generating a signal indicating the determined placement.

2. The method of claim 1, wherein:
the optimization algorithm is an adapted simulated annealing algorithm.

3. The method of claim 1, wherein:
the metadata regarding revenue generating characteristics includes historical data regarding the revenue-generating characteristics for the advertisements.

4. The method of claim 3, wherein:
the historical data regarding the revenue-generating characteristics for the advertisements includes data regarding revenue generation as a function of item placement.

5. The method of claim 2, wherein:
the simulated annealing algorithm simulates energy associated with states that correspond to placement of revenue generating items relative to a display.

6. The method of claim 1, further comprising:
causing the signal indicating the determined placement to be recorded on a tangible recording medium such that the signal indicating the determined placement is computer-readable.

7. The method of claim 1, further comprising:
repeating the receiving, applying and generating steps for a plurality of indications of advertisements to display.

8. The method of claim 7, further comprising:
causing the signals indicating the determined placements to be recorded on at least one tangible recording medium such that the signals indicating the determined placements are computer-readable.

9. A computer program product to determine placement of advertisements on a display, the computer program product comprising at least one computer-readable medium having computer program instructions stored therein which are operable to cause at least one computing device to:
receive an indication of the advertisements to display;
apply an iterative optimization algorithm to metadata regarding revenue-generating characteristics for the advertisements to determine a placement of the advertisements relative to a display; and
generate a signal indicating the determined placement.

10. The computer program product of claim 9, wherein:
the optimization algorithm is an adapted simulated annealing algorithm.

11. The computer program product of claim 9, wherein:
the metadata regarding revenue generating characteristics includes historical data regarding the revenue-generating characteristics for the advertisements.

12. The computer program product of claim 11, wherein:
the historical data regarding the revenue-generating characteristics for the advertisements includes data regarding revenue generation as a function of item placement.

13. The computer program product of claim 10, wherein:
the simulated annealing algorithm simulates energy associated with states that correspond to placement of revenue generating items relative to a display.

14. The computer program product of claim 9, wherein the computer program instructions further include computer program instructions operable to cause the at least one computing device to:
cause the signal indicating the determined placement to be recorded on a tangible recording medium such that the signal indicating the determined placement is computer-readable.

15. The computer program product of claim 9, wherein the computer program instructions further include computer program instructions operable to cause the at least one computing device to:
repeat the receiving, applying and generating steps for a plurality of indications of advertisements to display.

16. The computer program product of claim 15, wherein the computer program instructions further include computer program instructions operable to cause the at least one computing device to:
cause the signals indicating the determined placements to be recorded on at least one tangible recording medium such that the signals indicating the determined placements are computer-readable.

17. A computing system configured to determine placement of advertisements on a display, the computing system configured to:
receive an indication of the advertisements to display;
apply an iterative optimization algorithm to metadata regarding revenue-generating characteristics for the advertisements to determine a placement of the advertisements relative to a display; and
generate a signal indicating the determined placement.

18. The computing system of claim 17, wherein:
the optimization algorithm is an adapted simulated annealing algorithm.

19. The computing system of claim 17, wherein:
the metadata regarding revenue generating characteristics includes historical data regarding the revenue-generating characteristics for the advertisements.

20. The computing system of claim 19, wherein:
the historical data regarding the revenue-generating characteristics for the advertisements includes data regarding revenue generation as a function of item placement.

21. The computing system of claim 18, wherein:
the simulated annealing algorithm simulates energy associated with states that correspond to placement of revenue generating items relative to a display.

22. The computing system of claim 17, the computing system further configured to:
cause the signal indicating the determined placement to be recorded on a tangible recording medium such that the signal indicating the determined placement is computer-readable.

23. The computing system of claim 17, the computing system further configured to:
repeat causing the receiving, applying and generating for a plurality of indications of advertisements to display.

24. (canceled)

25. A method of processing a search term, comprising:
based on the search term, receiving an indicated placement of advertisements to be displayed in conjunction with search results corresponding to the search term, where the determined indicated placement of advertisements has been determined by applying an iterative optimization algorithm to revenue generation characteristics that correspond to a list of advertisements for the search term; and
causing the advertisements to be displayed, in conjunction with the search results, in accordance with the indicated placement.

26. The method of claim 25, further comprising:
causing determination of the search results corresponding to the search term.

27-29. (canceled)
